(19) United States
(12) Patent Application Publication
(10) Pub. No.: US 2016/0044864 A1
(43) Pub. Date: Feb. 18, 2016

(54) REPLACEABLE TRIMMER LINE DEVICE

(71) Applicant: Martin Hermann, Mona Vale NSW 1660 (AU)

(72) Inventor: Martin Hermann, Mona Vale NSW 1660 (AU)

(21) Appl. No.: 14/457,254

(22) Filed: Aug. 12, 2014

(51) Int. Cl. A01D 34/416

(52) U.S. Cl. CPC A01D 34/4166; A01D 34/4168

(57) ABSTRACT

A replaceable trimmer line device facilitates changing of trimmer line extending from a trimmer head. The device includes a line connector having opposite ends coupled to a trimmer head. A line socket extends through the line connector. A trimmer line has a head section and a cutting section. The cutting section extends from the head section. The head section is positionable in the socket such that the cutting section extends laterally from the line connector and outwardly from the trimmer head.

### BACKGROUND OF THE DISCLOSURE

### Field of the Disclosure

The disclosure relates to trimmer line devices and more particularly pertains to a new trimmer line device for facilitating changing of trimmer line extending from a trimmer head.

### SUMMARY OF THE DISCLOSURE

An embodiment of the disclosure meets the needs presented above by generally comprising a line connector having opposite ends coupled to a trimmer head. A line socket extends through the line connector. A trimmer line has a head section and a cutting section. The cutting section extends from the head section. The head section is positionable in the socket such that the cutting section extends laterally from the line connector and outwardly from the trimmer head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side view of a replaceable trimmer line device according to an embodiment of the disclosure.

FIG. 2 is a front view of an embodiment of the disclosure.

FIG. 3 is a back view of an embodiment of the disclosure.

FIG. 4 is a top view of an embodiment of the disclosure.

FIG. 5 is a bottom view of alternative trimmer lines of an embodiment of the disclosure.

FIG. 6 is a top front side perspective view of alternative embodiments of the disclosure.

FIG. 7 is a partial cut-away side view of an embodiment of the disclosure.

### DESCRIPTION OF THE PREFERRED EMBODIMENT

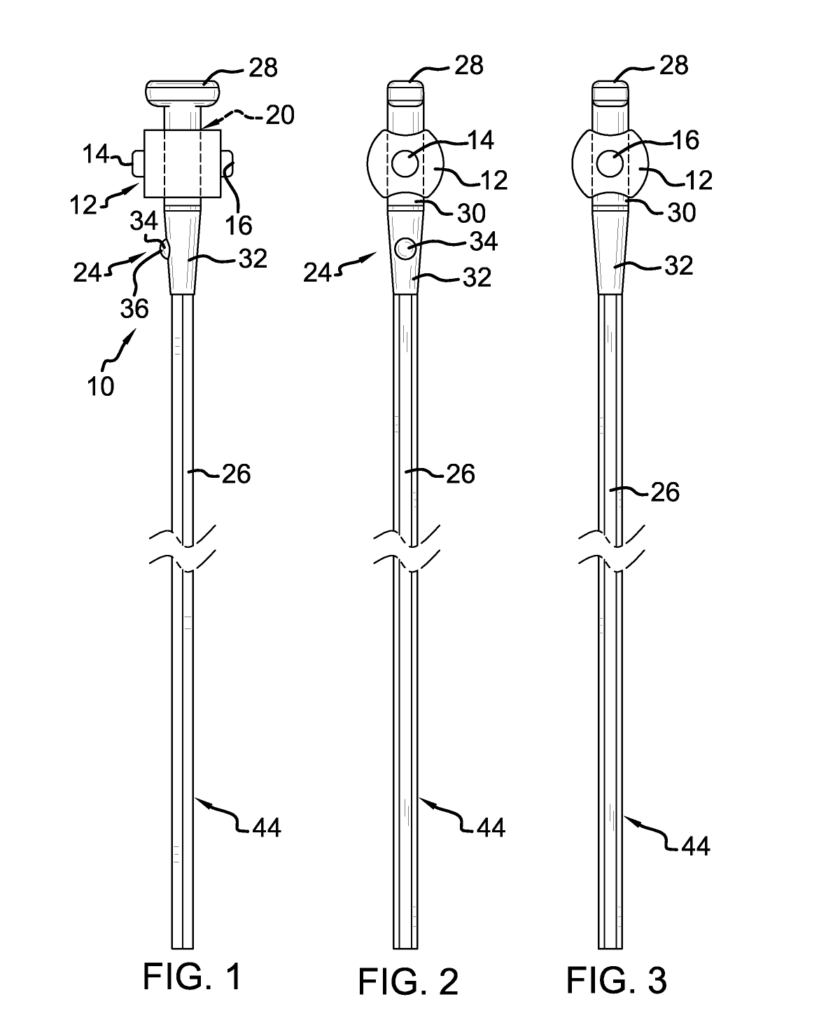

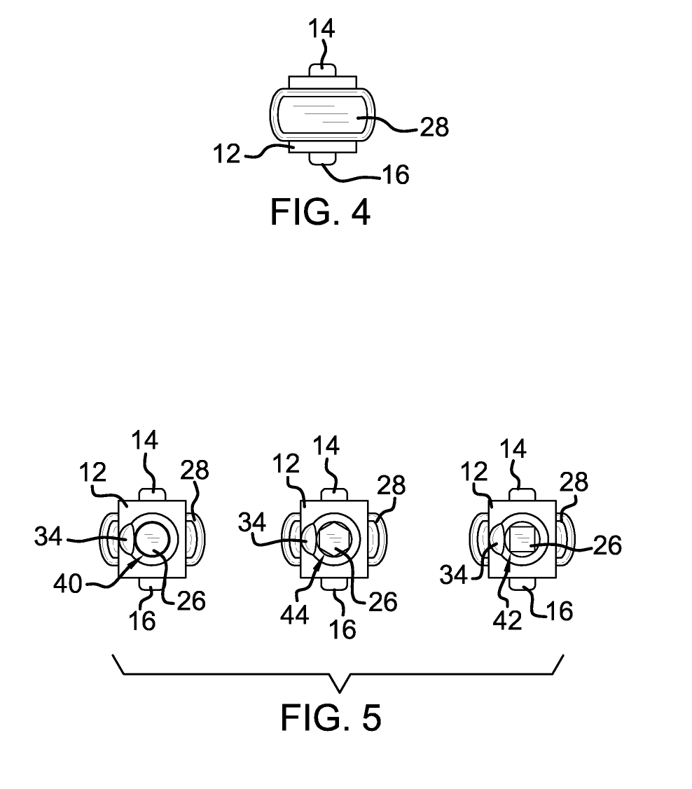

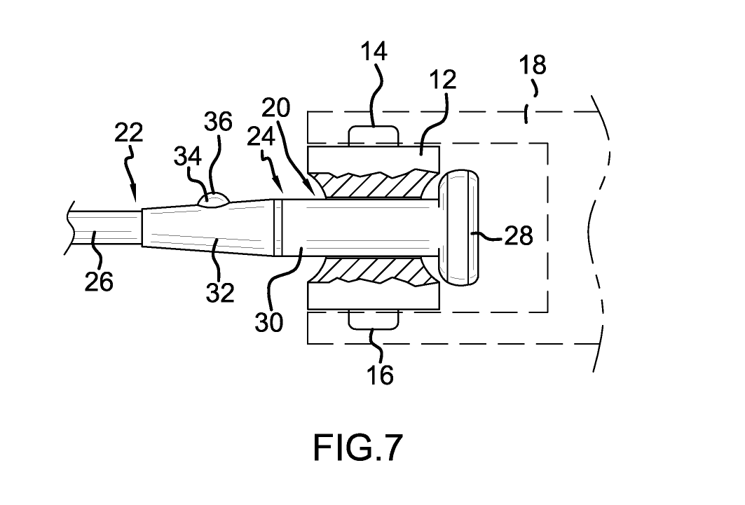

With reference now to the drawings, and in particular to FIGS. 1 through 7 thereof, a new trimmer line device embodying the principles and concepts of an embodiment of the disclosure and generally designated by the reference numeral 10 will be described.

As best illustrated in FIGS. 1 through 7, the replaceable trimmer line device 10 generally comprises a line connector 12 having opposite ends 14,16 coupled to a trimmer head 18. The line connector 12 may be one of two or more line connectors 12 which are substantially cylindrical and couplable to the trimmer head 18 in a manner permitting the line connectors 12 to swivel relative to the trimmer head 18. A line socket 20 extends through the line connector 12. The line socket 20 may be cylindrical and transverse to a longitudinal axis of the line connector 12.

A trimmer line 22 has a head section 24 and a cutting section 26 which extends from the head section 24. The head section 24 is positionable in the line socket 20 such that the cutting section 24 extends laterally from the line connector 12 and outwardly from the trimmer head 18. The head section 24 of the trimmer line 22 further comprises a flange portion 28 and a seat portion 30. The flange portion 28 extends laterally outward from the seat portion 30 wherein the flange portion 28 abuts the line connector 12 when the seat portion 30 is positioned in the line socket 20. Thus, the flange portion 28 prevents the trimmer line 22 from passing fully through the line socket 20. The flange portion 28 may be substantially rectangular extending across and outward from opposite sides of an end 68 of the seat portion 30.

The head section 24 of the trimmer line 22 further comprises a tapered portion 32 extending between the seat portion 30 and the cutting section 26 of the trimmer line 22. The tapered portion 32 tapers from the seat portion 30 extending towards the cutting section 26 of the trimmer line 22. A nub 34 is coupled to the trimmer line 22. The nub 34 extends laterally outward from the trimmer line 22 such that the nub 34 inhibits the trimmer line 22 from being removed from the line connector 12 after the trimmer line 22 is extended through the line socket 12 to position the seat portion 30 of the head section 24 in the line socket 20. The nub 34 is positioned on and extends outwardly from the tapered portion 32 of the head section 24. An outermost surface 36 of the nub 34 relative to a longitudinal axis of the trimmer line 22 is positioned to contact the line connector 12 adjacent to the line socket 20 when the trimmer line 22 is in a straight position. The trimmer line 22 is constructed of a durable hard plastic or the like. The trimmer line 22 is substantially stiff and resilient to be in the straight position until acted upon by an outside force. Positioning of the nub 34 on the tapered portion 32 of the head section 24 allows the outermost surface 36 of the nub 34 to be moved into and through the line socket 20 when force is applied to the trimmer line 22. Thus, the trimmer line 22 may be inserted through and removed from the line connector 12 as desired to replace the trimmer line 22 whenever desired.

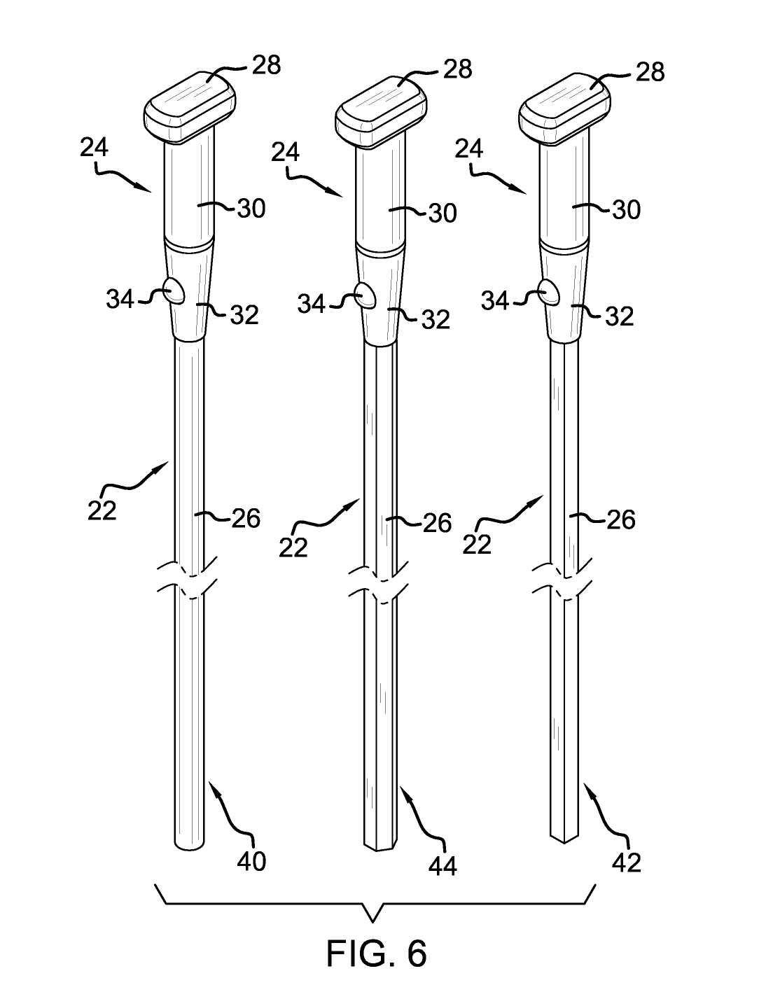

As shown in the alternative trimmer lines 22 in FIGS. 5 and 6, the cutting section 26 of the trimmer line 22 may be designed having a circular cross-sectional shape 40 transverse to a longitudinal axis of the trimmer line 22, a square cross-sectional shape 42 transverse to a longitudinal axis of the trimmer line 22, or a hexagonal cross-sectional shape 44 transverse to a longitudinal axis of the trimmer line 22. Trimmer lines 22 having a desired shape or length for the cutting section 26 may be interchanged or replaced as desired based on personal preference or the desired characteristics for cutting vegetation or other material using the trimming line 22.

In use, length and weight of the cutting section 26 of the trimmer line 22 relative to the head section 24 positioned opposite a center of the line socket 20 will orient the trimmer line 22 to extend outwardly from the trimmer head 18 as the trimmer head 18 is rotated. Thus, the trimmer line 22 may be used in a conventional manner as the trimmer head 18 rotates, typically at high speed. In the event of damage to the trimmer line 22, or a desire to provide an alternative trimmer line 22 to change cutting characteristics during use, the engaged trimmer line 22 is pushed back through the line socket 20 and a new trimmer line 22 may be installed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A replaceable trimmer line device comprising:
a line connector having opposite ends coupled to a trimmer head;
a line socket extending through said line connector; and
a trimmer line having a head section and a cutting section, said cutting section extending from said head section, said head section being positionable in said socket such that said cutting section extends laterally from said line connector and outwardly from said trimmer head.

2. The device of claim 1, further comprising said cutting section of said trimmer line having a circular cross-sectional shape transverse to a longitudinal axis of said trimmer line.

3. The device of claim 1, further comprising said cutting section of said trimmer line having a square cross-sectional shape transverse to a longitudinal axis of said trimmer line.

4. The device of claim 1, further comprising said cutting section of said trimmer line having a hexagonal cross-sectional shape transverse to a longitudinal axis of said trimmer line.

5. The device of claim 1, further comprising said head section of said trimmer line comprising a flange portion and a seat portion, said flange portion extending laterally outward from said seat portion wherein said flange portion abuts said line connector when said seat portion is positioned in said line socket whereby said flange portion prevents said trimmer line from passing fully through said line socket.

6. The device of claim 1, further comprising a nub coupled to said trimmer line, said nub extending laterally outward from said trimmer line such that said nub inhibits said trimmer line from being removed from said line connector after said trimmer line is extended through said line socket.

7. The device of claim 5, further comprising said head section of said trimmer line comprising a tapered portion extending between said seat portion and said cutting section of said trimmer line, said tapered portion tapering from said seat portion extending towards said cutting section of said trimmer line.

8. The device of claim 7, further comprising a nub coupled to said trimmer line, said nub extending laterally outward from said trimmer line such that said nub inhibits said trimmer line from being removed from said line connector after said trimmer line is extended through said line socket, said nub being positioned on and extending outwardly from said tapered portion of said head section.

9. A replaceable trimmer line device comprising:
a line connector having opposite ends coupled to a trimmer head;
a line socket extending through said line connector;
a trimmer line having a head section and a cutting section, said cutting section extending from said head section, said head section being positionable in said socket such that said cutting section extends laterally from said line connector and outwardly from said trimmer head, said head section of said trimmer line comprising a flange portion and a seat portion, said flange portion extending laterally outward from said seat portion wherein said flange portion abuts said line connector when said seat portion is positioned in said line socket whereby said flange portion prevents said trimmer line from passing fully through said line socket, said head section of said trimmer line comprising a tapered portion extending between said seat portion and said cutting section of said trimmer line, said tapered portion tapering from said seat portion extending towards said cutting section of said trimmer line; and
a nub coupled to said trimmer line, said nub extending laterally outward from said trimmer line such that said nub inhibits said trimmer line from being removed from said line connector after said trimmer line is extended through said line socket, said nub being positioned on and extending outwardly from said tapered portion of said head section.

10. The device of claim 9, further comprising said cutting section of said trimmer line having a circular cross-sectional shape transverse to a longitudinal axis of said trimmer line.

11. The device of claim 9, further comprising said cutting section of said trimmer line having a square cross-sectional shape transverse to a longitudinal axis of said trimmer line.

12. The device of claim 9, further comprising said cutting section of said trimmer line having a hexagonal cross-sectional shape transverse to a longitudinal axis of said trimmer line.
